(19) United States
(12) Patent Application Publication
(10) Pub. No.: US 2014/0002629 A1
(43) Pub. Date: Jan. 2, 2014

(54) ENHANCED PERIPHERAL VISION EYEWEAR AND METHODS USING THE SAME

(71) Applicants: Joshua J. Ratcliff, Santa Clara, CA (US); Kenton M. Lyons, Santa Clara, CA (US)

(72) Inventors: Joshua J. Ratcliff, Santa Clara, CA (US); Kenton M. Lyons, Santa Clara, CA (US)

(21) Appl. No.: 13/537,178

(22) Filed: Jun. 29, 2012

(51) Int. Cl. H04N 7/18; G02C 11/00

(52) U.S. Cl. 348/78; 351/158; 348/E07.085

(57) ABSTRACT

A system and method for enhancing the peripheral vision of a user is disclosed. In some embodiments, the systems and methods image objects outside the field of view of the user with at least one sensor. The sensor may be coupled to eyewear that is configured to be worn over the eye of a user. Upon detection of said object(s), an indicator may be displayed in a display coupled to or integral with a lens of the eyewear. The indicator may be produced in a region of the display that is detectable by the user's peripheral vision. As a result, the user may be alerted to the presence of objects outside his/her field of view. Because the indicator is configured for detection by the user's peripheral vision, impacts on the user's foveal vision may be limited, minimized, or even eliminated.

### TECHNICAL FIELD

The present disclosure relates to methods and apparatus for enhancing peripheral vision, including but not limited to eyewear for enhancing the peripheral vision of a human.

### BACKGROUND

The vision of many animals is not uniform and has a limited field of view. In the case of humans for example, the fovea (central region) of the retina has more spatial resolution than the periphery of the retina, which is very sensitive to motion. Moreover, the human eye has a field of view that limits or prevents the eye from seeing objects outside of that field. By way of example, if a human has eyes with a 180 degree horizontal field of view, he/she will not be able to see objects outside that field of view without turning his/her head in an appropriate direction.

There are many instances in which an individual may be interested in the presence of an object outside of their field of view, but is unable or unaware of the need to turn and look for such object. Bicyclists for example are often concerned with the presence of motor vehicles (cars, trucks, motorcycles, etc.) outside of their field of view. It is often the case that a motor vehicle may rapidly approach a bicyclist from the rear. The bicyclist may therefore not learn of the presence and/or approach of the motor vehicle until it is in very close proximity. In such instances there is significant risk that the bicyclist may turn into the pathway of the motor vehicle, resulting in disastrous consequences for both the bicyclist and the motor vehicle operator.

Of course, there are many other circumstances in which a human may be interested in the presence and/or approach of an object outside their field of view. For example, law enforcement officers are often tasked with visually monitoring a location, arresting individuals, performing crowd control, etc. In these and other situations, an officer may be interested to know of the presence and/or approach of individuals and objects outside their field of view. This is particularly true in cases where a criminal may attempt to sneak up on and/or debilitate the officer from a location outside the officer's field of view (e.g., from behind). If the officer were aware of the presence and/or approach of the criminal, such attempt might be thwarted.

Many technologies have been developed to assist humans to visualize or become aware of objects outside of their field of view. For example, mirrors have been adapted for use on bicycles, motor vehicles, and glasses. Such mirrors can help their respective users see objects beyond their natural field of view, e.g., behind them. However, such minors typically require the user to focus his/her gaze on the mirror itself, distracting the user from seeing objects that are in front of him or her. Mirrors used in this manner are also indiscrete, and may provide little or inaccurate information about the distance and rate of approach of objects outside the user's field of view.

In addition to minors, blind spot detection systems have been developed for motor vehicles such as cars and trucks. Such systems can aid an operator to detect the presence of other vehicles that are in a blind spot, to the side, and/or to the rear of the operator's vehicle. Although useful, such systems are designed for mounting to an automobile and thus are not wearable by a human. Moreover, many of such systems alert a vehicle operator to the presence of objects in the vehicle's blind spot by displaying a visual indicator at a position that is outside the operator's field of view (e.g., on the dashboard or instrument panel). Thus, operators must shift their gaze to the location of the visual indicator. Thus, like minors, such systems can distract an operator from seeing objects that are in front of his or her vehicle, while the operator is inspecting the visual indicator.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 is a block diagram illustrating an exemplary overview of a system in accordance with the present disclosure;

FIG. 2 is a perspective view of an exemplary system in accordance with the present disclosure, as implemented in eyewear;

FIG. 3A is a top down view illustrating the field of view of exemplary human eyes relative to the field of view of a system in accordance with the present disclosure;

FIG. 3B is a front view of two exemplary eyeglass lenses including a display in accordance with non-limiting embodiments of the present disclosure; and

FIG. 4 is a flow diagram of an exemplary method in accordance with the present disclosure.

Although the following detailed description proceeds with reference made to illustrative embodiments, many alternatives, modifications, and variations thereof will be apparent to those skilled in the art.

### DETAILED DESCRIPTION

For the purpose of the present disclosure the terms “foveal vision” and “center of gaze” are interchangeably used to refer to the part of the visual field that is produced by the fovea of the retina in a human eye. As may be understood, the fovea is a portion of the macula of a human eye. In a healthy human eye, the fovea typically contains a high concentration of cone shaped photoreceptors relative to regions of the retina outside the macula. This high concentration of cones can allow the fovea to mediate high visual acuity. In contrast, the term “peripheral vision” is used herein to refer to the part of the visual field outside the center of gaze, i.e., outside of foveal vision. As may be understood, peripheral vision may be produced by regions outside of the macula of the human retina, e.g., by the periphery of the retina. As may be understood, the periphery of a human retina generally contains a low concentration of cone shaped photoreceptors, and thus does not produce vision with high acuity. Because the periphery of a human retina contains a high concentration of rod shaped photoreceptors, however, peripheral vision of many humans is highly sensitive to motion.

The term “eyewear” is used herein to generally refer to objects that are worn over one or more eyes. Non-limiting examples of eyewear include eye glasses (prescription or non-prescription), sunglasses, goggles (protective, night vision, underwater, or the like), a face mask, combinations thereof, and the like. In many instances, eyewear may enhance the vision of a wearer, the appearance of a wearer, or another aspect of a wearer.

The present disclosure generally relates to systems and methods for enhancing peripheral vision, and in particular the peripheral vision of a human being. As described further below, the systems and methods described herein may utilize one or more sensors mounted to a wearable article such as but not limited to eyewear. The sensor(s) may operate to detect the presence of objects (e.g., automobiles, bicycles, other humans, etc.) outside the field of view of a user of the wearable article. Data from the sensor(s) may be processed to determine the position of the detected object relative to the sensor and or a user (wearer) of the wearable article. An indicator reflecting the existence and relative position of the detected object may then be presented on a display such that may be detected by the peripheral vision of the user. In this way, the systems and methods of the present disclosure may alert the user to the presence of an object outside his or her field of few, while having little or no impact on the user's foveal vision.

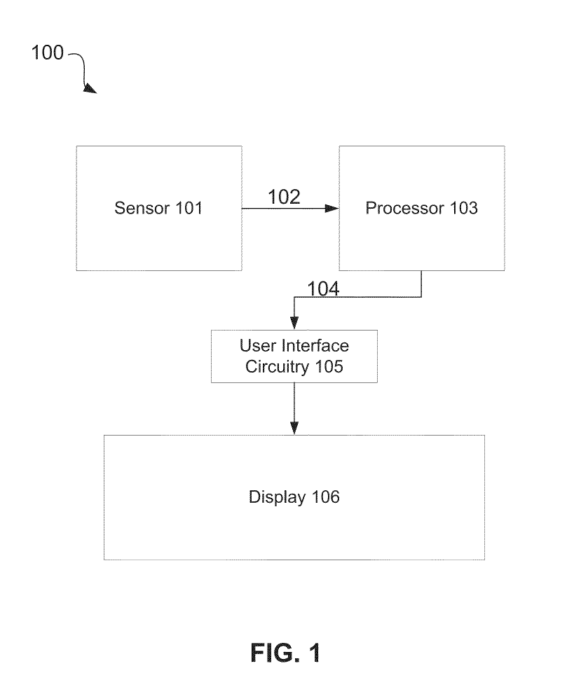

Reference is now made to FIG. 1, which is a block diagram of an exemplary system overview consistent with the present disclosure. As shown, system 100 includes sensor 101, processor 103, user interface circuitry 105, and display 106. Sensor 101 may be any type of sensor that is capable of detecting objects of interest to a user. For example, sensor 101 may be chosen from an optical sensor such as a stereo (two dimensional) camera, a depth (three dimensional) camera, combinations thereof, and the like; an optical detection and ranging system such as a light imaging detection and ranging (LIDAR) system; a radio frequency detection and ranging (RADAR) detector; an infrared sensor; a photodiode sensor; an audio sensor; another type of sensor; combinations thereof; and the like. In some non-limiting embodiments, sensor 101 is chosen from a stereo camera, a depth camera, a LIDAR sensor, and combinations thereof.

Alternatively or additionally, sensor 101 may be configured to detect the presence of one or more objects through one or more wireless communications technologies such as BLUETOOTH™, near field communication (NFC), a wireless network, a cellular phone network, or the like. In such instances, sensor 101 may detect the presence of one or more transponders, transmitters, beacons, or other communications device that may be in, attached, or coupled to an object within sensor 101's field of view.

Sensor 101 may be capable of imaging the environment within its field of view. As used herein, the terms “image” and “imaging” when used in the context of the operation of a sensor mean that data is gathered by the sensor about the environment within its field of view. Thus for example, the present disclosure envisions sensors that image objects in the environment within their field of view by recording and/or monitoring some portion of the electromagnetic spectrum. By way of example, sensor 101 may be configured to record and/or monitor the infrared, visual, and/or ultraviolet spectrum in its field of view. Alternatively or additionally, sensor 101 may image objects in the environment within its field of view by recording and/or monitoring auditory information.

In some embodiments, sensor 101 has a field of view that is larger in at least one dimension than the corresponding dimension of the field of view of a user. Thus for example, sensor 101 may have a horizontal and/or vertical field of view that is greater than or equal to about 160 degrees, greater than or equal to about 170 degrees, or even greater than or equal to about 180 degrees. Of course, such fields of view are exemplary only, and sensor 101 may have any desired field of view.

In instances where sensor 101 has a larger field of view than the eyes of a user (e.g., a human), sensor 101 may operate to image objects that are outside the field of view of the user even if its field of view is oriented in the same direction as the user's gaze. Alternatively or additionally, sensor 101 may be mounted or otherwise oriented such that its field of view encompasses regions outside the field of view of a user, e.g., behind and/or to the side of the user's eyes. In such instances, sensor 101 may image regions of the environment that are outside the user's field of view. As may be appreciated, sensor 101 can have any desired field of view when oriented in this manner.

In the process of imaging the environment within its field of view, sensor 101 may image objects that may be of interest to a user. Non-limiting examples of such objects include animals (e.g., humans, deer, moose, rodents, combinations thereof, and the like), metallic objects (e.g., motor vehicles such as cars, trucks, motorcycles, combinations thereof, and the like), and non-metallic objects. In some embodiments, sensor 101 is configured to image motor vehicles, animals (e.g., humans), and combinations thereof.

Although FIG. 1 depicts a system in which a single sensor 101 is used, it should be understood system 100 may include any number of sensors. For example, system 100 may utilize 1, 2, 3, 4, or more sensors. In some non-limiting embodiments, system 100 includes two sensors 101.

As sensor 101 images objects in the environment within its field of view, it may output sensor signal 102 to processor 103. Sensor 101 may therefore be in wired and/or wireless communication with processor 103. Regardless of the mode of communication, sensor signal 102 may be any type of signal conveying data about the image of the environment within sensor 101's field of view. Thus for example, sensor signal 102 may an analog or digital signal conveying still images, video images, stereoscopic data, auditory data, other types of information, combinations thereof, and the like to processor 103.

Processor 103 may be configured to analyze sensor signal 102 and determine the presence (or absence) of objects in the environment within sensor 101's field of view. The type of analysis performed by processor 103 may depend on the nature of the data conveyed by sensor signal 102. In instances where sensor signal 102 contains still and/or video images, for example, processor 103 may utilize depth segmentation, image recognition, machine learning methods for object recognition, other techniques, and combinations thereof to determine the presence of objects in sensor 101's field of view from such still and/or video images. In circumstances where sensor signal 102 contains auditory information, processor 103 may utilize sound source localization, machine learning classification, the Doppler effect, other techniques, and combinations thereof to determine the presence of objects in sensor 101's field of view from auditory information.

While processor 103 may be configured to identify specific information about an object of interest (e.g., the make and model of a car in sensor 101's field of view, for example), such identification is not required. Indeed in some embodiments processor 101 is configured to merely to detect the presence of an object in sensor 101's field of view. Alternatively or additionally, processor 103 may be configured to detect and distinguish between broad classes of objects that are detected in the field of view of sensor 101. For example, processor 103 may be configured to detect and distinguish between animals (e.g. humans), metallic objects (e.g. automobiles, bicycles, etc.) and non-metallic objects that are imaged by sensor 101.

In addition to determining whether or not an object is present in the field of view of sensor 101, processor 103 may be configured to determine the position of such object relative to sensor 101 and/or a user. For example, processor 103 may be coupled to memory (not shown in FIG. 1) having calibration data stored therein which identifies the position and/or orientation of sensor 101 relative to a known point. Thus, if processor 103 detects the presence of an object within the field of view of sensor 101, the relative position (front, rear, left, right, etc.) of the object relative to the known point may be determined. For example, if a system in accordance with the present disclosure is mounted to or otherwise forms a part of a wearable article such as eye glasses, calibration data stored in memory may allow processor 103 to know the position and/or orientation of sensor 101 on the eye glasses, relative to a known point. In such instances, the known point may be a location on the eye glasses (e.g., the bridge), a point defined by an intersection of a line bisecting the bridge and a line bisecting the middle point of the arms of the eye glasses, the mounting location of the sensor, another point, and combinations thereof. When the eyeglasses are worn by a user, processor 103 may use this calibration data to determine the relative position of objects detected in the field of view of sensor 101, relative to the known point and, by extension, the user.

In some embodiments, processor 103 may be configured to determine the distance of an object detected in sensor 101's field of view, relative to a known point and/or a user. For example, processor 103 may configured to calculate or otherwise determine the presence of objects within a threshold distance of a user and/or sensor 101. Such threshold distance may range, for example, from greater than 0 to about 50 feet, such as about 1 to about 25 feet, about 2 to about 15 feet, or even about 3 to about 10 feet. In some embodiments, processor 103 may determine the presence of objects that are less than about 10 feet, about 5 feet, about 3 feet, or even about 1 foot from sensor 101 and/or a user. Of course, such ranges are exemplary only, and processor 103 may be capable of calculating or otherwise detecting the presence of objects at any range.

Although the present disclosure envisions systems in which processor 103 is configured or otherwise specifically designed to analyze sensor signals and perform object detection (e.g., in the form of an application specific processor such as an application specific integrated circuit), such a configuration is not required. Indeed, processor 103 may be a general purpose processor that is configured to execute object detection instructions which cause it to perform object detection operations consistent with the present disclosure. Such object detection instructions may be stored in a memory (not shown) that is local to processor 103, and/or in another memory such as memory within user interface circuitry or other circuitry. Such memory may include one or more of the following types of memory: semiconductor firmware memory, programmable memory, non-volatile memory, read only memory, electrically programmable memory, random access memory, flash memory (which may include, for example, NAND or NOR type memory structures), magnetic disk memory, and/or optical disk memory. Additionally or alternatively, memory 213 may include other and/or later-developed types of computer-readable memory. In some embodiments, memory 213 can be local to host processor 207, local to security engine 212, or local to another embedded processor (not shown) within chipset circuitry 211. It should therefore be understood that object detection instructions may be stored in a computer readable medium, and may cause a processor to perform object detection operations when they are executed by such processor.

As noted previously, sensor 101 may be configured with ranging capabilities. In such instances sensor signal 102 may include information indicative of the range of objects (hereafter, “ranging information”) in the environment imaged by sensor 101. In such instances, processor 103 may be configured to analyze sensor signal 102 for such ranging information and determine the relative distance of objects imaged by sensor 101 from such information. In instances where sensor 101 is or includes a stereo camera, processor 103 may use stereo correspondence algorithms determine the distance of an object from a sensor. For example, processor 103 may measure pixel wise shifts between left/right image pairs, with larger shifts indicating that the object is further away. In connection with sensor mounting information and sensor specifications, such pixel wise shifts can enable processor 103 to determine the real world X, Y, and Z coordinates of each pixel in an image, and produce a depth map. In any case, processor 103 may use ranging information in sensor signal 102 to determine the distance of objects imaged by sensor 101 with a relatively high degree of accuracy. In some embodiments for example, processor 103 is capable of determining the distance of objects imaged by sensor 101 with an accuracy of plus or minus about 3 feet, about 2 feet, or even about 1 foot.

Processor 103 may also be configured to determine the rate at which detected objects are approaching sensor 101, a known point, and/or a user of a system in accordance with the present disclosure. In instances where sensor 101 is or includes a depth or stereo camera, for example, processor 103 can determine rate of movement by analyzing the change in position of an object on a depth map, e.g., on a frame by frame basis. In instances where sensor signal 102 includes auditory information, the rate of approach of an object may be determined by processor 103 using the Doppler effect. And in instances where sensor 101 is or includes a RADAR or LIDAR system, rate information may be determined by processor 103 by determining the change in the position of an object detected by such a system, relative to the position of the sensor.

Processor 103 may also be configured to determine the number of objects in the environment imaged by sensor 101. In some embodiments, processor 103 may be capable of detecting and distinguishing greater than 0 to about 5 objects or more, such as about 1 to about 10, about 1 to about 20, or even about 1 to about 25 objects in the environment imaged by sensor 101. Of course, such ranges are exemplary only, and processor 103 may be configured to detect and distinguish any number of objects that are imaged by sensor 101.

After detecting an object within sensor 101's field of view, processor 103 may output detection signal 104 to user interface circuitry 105. Accordingly, processor 103 may be in wired and/or wireless communication with user interface circuitry 105. Regardless of the mode of communication, detection signal 104 may be an analog or digital signal that conveys information about the objects detected by processor 103 to user interface circuitry 105. Thus for example, detection signal 104 may convey information about the type of objects detected, the number of objects detected, their relative position, their relative distance, other information, and combinations thereof.

In general, user interface circuitry 105 is configured to analyze detection signal 104 and cause one or more indicators to be produced on display 106. “Circuitry”, as used in any embodiment herein, may comprise, for example, singly or in any combination, hardwired circuitry, programmable circuitry, state machine circuitry, and/or firmware that stores instructions executed by programmable circuitry. In some embodiments, user interface circuitry 105 is integral to processor 103. In further non-limiting embodiments, user interface circuitry 105 is separate from processor 103. In such instances, user interface circuitry may take the form of a graphics processing unit, a video display chip, an application specific integrated circuit, combinations thereof, and the like. While the foregoing description and FIG. 1 depict user interface circuitry 105 and processor 103 as distinct components, such a configuration is not required. Indeed in some embodiments, user interface circuitry 105 may be integral with processor 103. In such instances, processor 103 may detect objects (as explained above) and output a detection signal to portions of the processor responsible for outputting a video signal. Accordingly, processor 103 may be a processor that is capable of performing general computing and video tasks. Non-limiting examples of such processors include certain models of the Ivy Bridge line of processors produced by Intel Corporation.

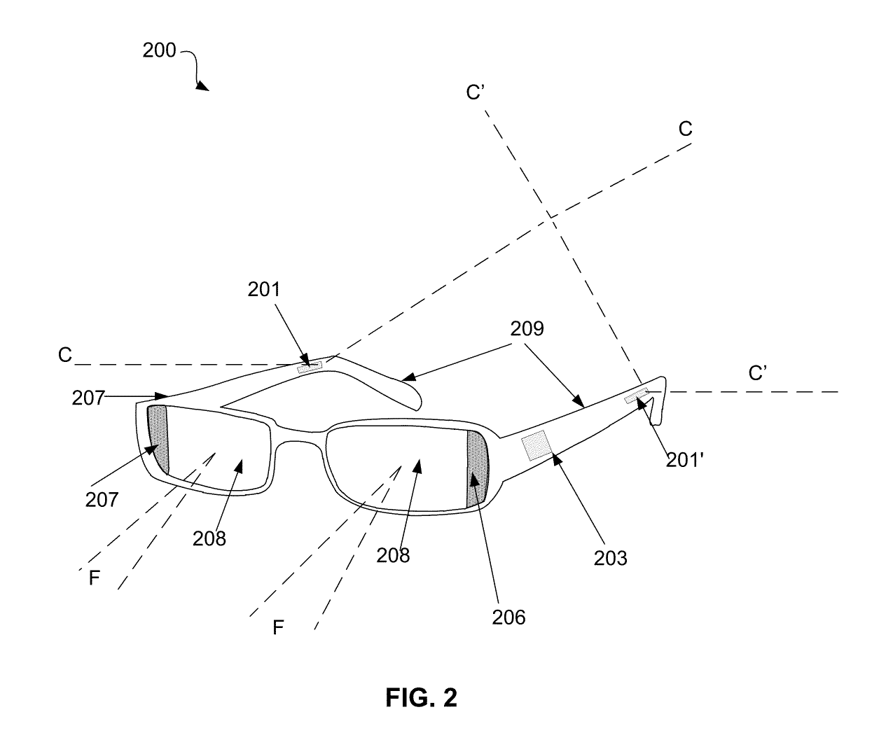

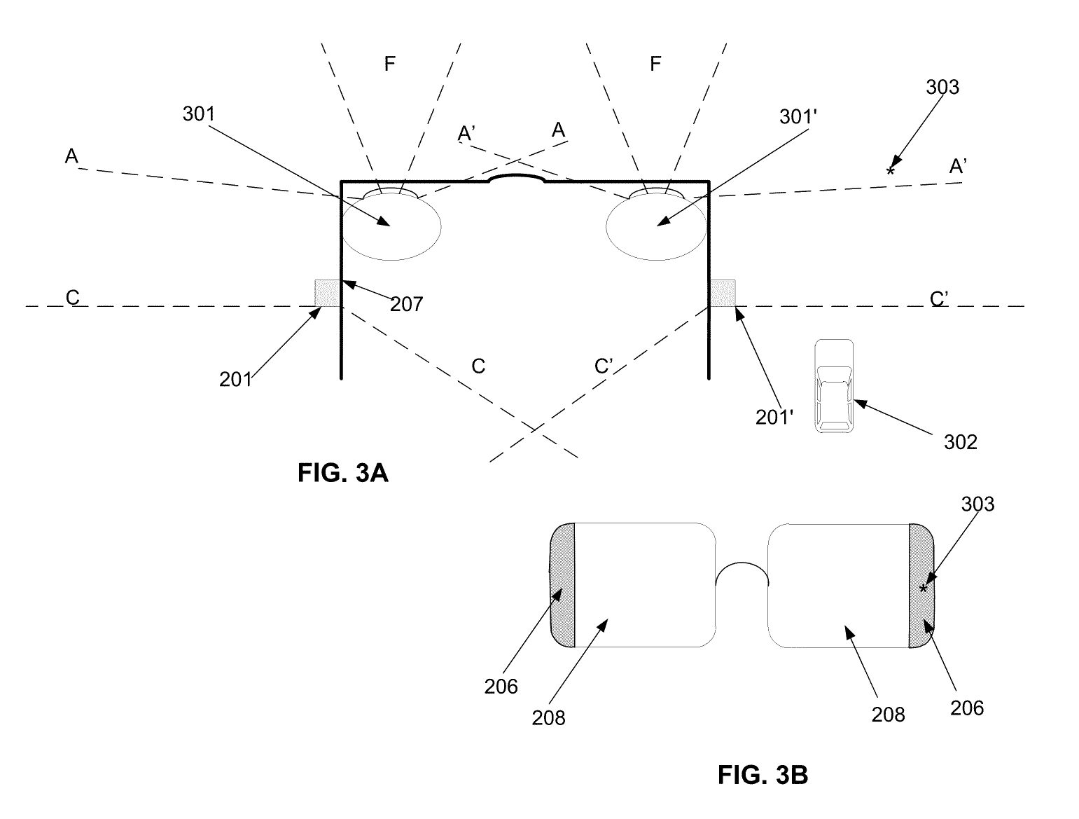

In some embodiments, user interface circuitry 105 is configured to interpret detection signal 104 and produce a video signal that causes one or more indicators to be produced on display 106. As will be discussed further below in connection with FIGS. 2, 3A, and 3B, user interface 105 may be configured to cause one or more indicators to be produced in a region of display 106 that is outside the foveal vision but within the peripheral vision of a user. In such instances, the indicators produced on display 106 may be placed such that they are perceived by a user with only his/her peripheral vision. By placing the indicators on display 106 in this manner, a user of a system in accordance with the present disclosure may be alerted to the presence of an object outside his/her field of view, without having to move or otherwise use his/her foveal vision to perceive the indicator.

While indicators consistent with the present disclosure may take the form of readable symbols (e.g., dots, x's, zeros, triangles, icons, numbers, letters etc.), use of readable symbols is not required. Indeed, because the indicators are produced on display 106 such that a user perceives them without their foveal vision (which most humans require for reading), such indicators need not be readable. Accordingly in some embodiments, the indicators produced on display 106 may be chosen from arbitrary symbols, white noise, fractal images, random and/or semi-random flashes, combinations thereof, and the like.

Although indicators consistent with the present disclosure may not be readable by a user, they may nonetheless perform the function of alerting the user to the presence of a detected object. Indeed, a user that perceives such an indicator with his or her peripheral vision may understand the indicator to mean that an object has been detected in a region outside his or her field of view. This may prompt the users to turn his or her head in an appropriate direction and look for the detected object. In addition to this minimum functionality, indicators consistent with the present disclosure may convey additional information about a detected object to a user. For example, indicators produced on display 106 may represent the type of detected object, the number of detected objects, the relative position of a detected object, the relative distance of a detected object from a user/sensor 101, the rate at which the detected object is approaching the user/sensor 101, urgency, combinations thereof, and the like. For the purpose of the present disclosure, an indicator that is not readable but which is capable of being understood by a user is referred to herein as an “intelligible indicator.”

Additional information about a detected object may be conveyed by controlling one or more parameters of an indicator produced on display 106. In this regard, display 106 may be capable of producing indicators of varying size, shape, position, intensity, pattern, color, combinations thereof, and the like. Likewise, display 106 may be capable of producing indicators that appear to be animated or otherwise in motion (e.g., flickering, blink, shimmer, and the like). User interface circuitry 105 may leverage these and other parameters to produce an indicator on display 106 that represents information contained in detection signal 104 regarding objects in sensor 101's field of view. In some embodiments, the number of objects in sensor 101's field of view is indicated by altering the size and/or intensity of the indicator, with a larger and/or more intense indicator meaning that more objects have been detected. Likewise, the rate at which a detected object is approaching may be indicated by changing the appearance of an indicator over time. In instances where an indicator is animated, flickers, or otherwise changes in appearance over time, the rate at which a detected object is approaching may be indicated by altering the rate at which the indicator changes, e.g., with a faster rate correlating to a more rapid approach. Similarly, urgency may be indicated by changing one or more of the foregoing parameters appropriately. For example, user interface circuitry 105 may appropriately change the brightness, animation speed, indicator pattern, etc. to convey an urgent need for a user to look to one direction or another.

Display 106 may be any type of display that is capable of producing an indicator consistent with the present disclosure. Non-limiting examples of such displays include a liquid crystal display (LCD), a light emitting diode (LED) display, a liquid crystal on silicon (LCoS) display, an organic electro luminescent display (OELD), an organic light emitting diode display (OLED), combinations thereof, and the like. Display 106 may be included in and/or form a portion of a wearable article such as eyewear. In some embodiments, display 106 forms or is included within an eyewear lens. In such instances, display 106 may form all or a portion of the eyewear lens, as described in detail below. Likewise, display 106 may be configured to produce symbols over all or a portion of an eyewear lens.

Display 106 may include a plurality of individually addressable elements, i.e., pixels. User interface circuitry 105 may interface with and control the output of such pixels so as to produce an indicator consistent with the present disclosure on display 106. The number of pixels in (i.e., resolution of) display 106 may impact the nature and type of indicators that it can display. As previously mentioned, display 106 may be capable of producing indicators with various adjustable features, e.g., size, shape, color, position, animation, etc.

As will be described in detail below, display 206 may be configured such that it is integrally formed with an eyewear lens. In such instances, display 106 may be formed such that it is capable of producing an indicator over all or a portion of the eyewear lens. In some embodiments, display 106 is configured such that it can produce indicators in a peripheral region of an eyewear lens. More specifically, display 106 may be configured to produce an indicator within a region R that is less than or equal to a specified distance from an edge of an eyewear lens. By way of example, if an eyewear lens has a width W and a height H (as shown in FIG. 3B, for example), the displays and user interface circuitry described herein may be configured to produce indicators in a region R extending less than or equal to 25% of W and/or H, such as less than or equal to 20% of W or H, less than or equal to 10% of W or H, or even less than or equal to 5% of W or H. Of course, such ranges are exemplary only, and display 106 may be configured to produce indicators in any desired region of an eyewear lens. Reference is now made to FIG. 2, which illustrates an exemplary eyewear apparatus including a system in accordance with the present disclosure. As shown, eyewear apparatus 200 includes frame 207 and lenses 208. For the sake of clarity, eyewear apparatus is illustrated in FIG. 2 in the form of eye glasses having two lenses 208 and two arms 209. It should be understood that the illustrated configuration is exemplary only, and that eyewear apparatus 200 may take another form. For example, eyewear apparatus may include a single lens, e.g., as in the case of a monocle. Eyewear apparatus 200 further includes sensors 201, 201′ which are coupled to arms 209 and function in the same manner as sensor 101 described above. In this context, the term “coupled” means that sensors 201, 201's are mechanically, chemically, or other otherwise attached to arms 209. Thus for example, sensors 201, 201′ may be attached to arms 209 via a fastener, an adhesive (e.g., glue), frictional engagement, combinations thereof, and the like. Of course, sensors 201, 201′ need not be coupled to eyewear apparatus 200 in this manner. Indeed, sensors 201, 201′ may be embedded and/or integrally formed with arms 209 or another portion of eyewear apparatus, as desired.

For the sake of illustration, sensors 201, 201′ are shown in FIG. 2 as coupled to arms 209 such that they have respective fields of view C and C′. As such, sensors 201, 201's may image the environment to the side and/or rear of eyewear apparatus 200, i.e., within fields of view C and C′, respectively. Of course, sensors 201, 201′ need not be positioned in this manner, and may have a field of view with any desired size. For example, one or more of sensors 201, 201′ may be located on or proximate to the portion of frame 207 surrounding lenses 208. Alternatively or additionally, one or more of sensors 201, 201′ may be coupled, integrated, or otherwise attached to the bridge of eyewear apparatus 200.

Eyewear apparatus further includes processor 203, which functions in the same manner as processor 103 discussed above in connection with FIG. 1. In this non-limiting embodiment, eyewear apparatus 200 is shown as including a single processor 203 embedded in one of arms 209. It should be understood that this configuration is exemplary only. Indeed, any number of processors may be used, and such processor(s) may be located at any suitable location on or within eyewear apparatus 200. In some non-limiting embodiments, processor 203 is embedded within the bridge of eyewear apparatus. In further non-limiting embodiments, eyewear apparatus 200 includes two processors, one for each of sensors 201 and 201′.

For the sake of clarity, user interface circuitry consistent with the present disclosure is not illustrated in FIG. 2. However, it should be understood that such circuitry is included in the system, either as a standalone component or as a part of processor 203. If user interface circuitry is included as a standalone component, it may be coupled, embedded or otherwise attached in and/or to any suitable portion of eyewear apparatus 200. For example, user interface circuitry may be embedded in a portion of frame 207 near the “temple” of lenses 208, i.e., in a region where arms 209 and the frame surrounding one of lens 208 meet. Alternatively or additionally, user interface circuitry may be embedded in a portion of arms 209, e.g., in a region behind a user's ear with the eyewear apparatus is worn.

Displays 206 may form or be incorporated into all or a portion of lens 208 of eyewear apparatus 200. In the non-limiting example shown in FIG. 2, displays 206 are limited to a peripheral region of lenses 208. In particular, displays 206 are located at regions of lenses 208 that are outside field of view F. Field of view F may be understood as the foveal field of view of a person wearing eyewear apparatus 200.

As field of view F may vary from person to person and/or from eye to eye, displays 206 may be sized, shaped, and/or positioned during the manufacture of eyewear apparatus 200 such that they are suitable for use by a desired population. For example, the size, shape and/or position of displays 206 may be determined based on data reporting the average foveal field of view of a desired population. If individuals in the desired population have an average horizontal foveal field of view of 15 degrees, displays 206 may be sized, shaped, and/or positioned appropriately such that they are outside of that angle when a user gazes through lenses 208. Alternatively or additionally, the size, shape and/or position of displays 206 may be tailored to a particular user, e.g., by taking into account various characteristics of the user's vision. In any case, displays 206 may be configured such that a user of eyewear apparatus 200 may perceive indicators on it with only his/her peripheral vision.

Of course, displays 206 need not be limited to regions of lenses 208 that are outside of field of view F. Indeed, displays 206 may be configured such that they extend across the entire or substantially the entire surface of lens 208. In such instances, user interface circuitry (not shown) may be configured to cause display 206 to produce indicators in regions of display(s) 206 that are outside field of view F. To accomplish this, user interface circuitry (and/or processor 203) may be coupled to memory (not shown) storing calibration information. Without limitation, such calibration information may contain information about a user's vision, such as the scope of the user's field of view F, peripheral vision, and the like. User interface circuitry (and/or processor 203) may use such calibration information to determine a region of display 206 overlaps with field of view F. User interface circuitry (and/or processor 203) may then block or otherwise prevent display 206 from producing indicators in such region.

To further explain the operation of an eyewear apparatus consistent with the present disclosure, reference is made to FIGS. 3A and 3B. FIG. 3A is a top down view of eyewear apparatus 200 shown in FIG. 2, as worn by a user having eyes 301, 301′. For simplicity, only frame 207 and sensors 201, 201′ of eyewear apparatus 200 are illustrated in FIG. 3A. As explained above, sensors 201, 201's are oriented such their respective fields of view (C, C′) enable them to image the environment to the rear and side of the field of view of eyes 301, 301′.

Eyes 301, 301′ represent the two eyes of a human user, and have fields of view F, F′, respectively. Fields of view F generally correlate to the foveal field of view of eyes 301, 301′. Eyes 301, 301′ are also illustrated as having respective fields of view A, A′. As shown, fields of view A, A′ are generally outside field of view F. As such, fields of view A, A′ may be understood as correlating to the peripheral field of view (i.e., peripheral vision) of eyes 301, 301′, respectively.

For the sake of illustration, FIG. 3A depicts a scenario in which a vehicle 302 approaches a user wearing an eyewear apparatus consistent with the present disclosure. As shown, vehicle 302 is outside fields of view F, F′, A, and A′, and thus is not visible to eyes 301, 301′. Vehicle 302 is within field of view C′ of sensor 201′, however, and thus may be imaged by sensor 201′ and detected by processor 203 (not shown). Upon detecting vehicle 302, processor 203 may send a detection signal to user interface circuitry (not shown). User interface circuitry may interpret the detection signal and cause display 206 to render indicator 303, as shown in FIG. 3B. In particular, user interface circuitry may cause display 206 to render indicator 303 within the peripheral fields of view A and/or A′ of eyes 301, 301′, and not fields of view F and/or F′.

User interface circuitry may cause indicators 303 to appear in a desired location of display(s) 206. For example, the user interface circuitry may cause indicator 303 to be produced at a location that is indicative of the position of a detected object, relative to a known location and/or a user. This concept is illustrated in FIGS. 3A and 3B, wherein user interface circuitry causes display 206 to render indicator 303 in a region of the right lens 208, such that it is perceptible to peripheral field of view A′ of eye 301′. As a result, the user may understand the presence of indicator 303 as indicating that an object has been detected in a region outside his/her field of view, and that the object is to the right of him/her. Similarly, user interface circuitry may be configured to cause display(s) 206 to render indicator 303 in another position. For example, if vehicle 302 is within field of view C (but not C′), user interface circuitry may cause display(s) 206 to render indicator 303 in a region of the left lens 208. And in instances where vehicle 302 is within fields of view C and C′ (e.g., where the two fields of view overlap), user interface circuitry may cause display(s) 206 to render indicator 303 in both the left and right lens 208. A user may understand the presence of indicator 303 in both the left and right lenses as indicating that an object is out of his/her field of view and is located behind him/her.

Put in other terms, displays and user interface circuitry consistent with the present disclosure may be configured to produce indicators in a region outside of the foveal field of view of an eye, when such foveal field of view is oriented along an axis perpendicular to and bisecting a center point of an eyewear lens. This concept is generally illustrated in FIGS. 3A and 3B, which illustrates eyes 301, 301′, each of which have a foveal field of view F that extends along an axis T bisecting a center point of each of eyewear lenses 208. As shown in these FIGS., foveal field of view F of eyes 301, 301′ has a horizontal width α, wherein α ranges from greater than 0 to about 15 degrees, greater than 0 to about 10 degrees, greater than 0 to about 5 degrees, or even greater than 0 to about 3.5 degrees. Consistent with the foregoing description, user interface circuitry and displays consistent with the present disclosure can produce an indicator (303) outside fovial field of view F of eyes 301, 301′. For example, user interface circuitry and displays consistent with the present disclosure that is within a region R (previously described) of one or both of lenses 208.

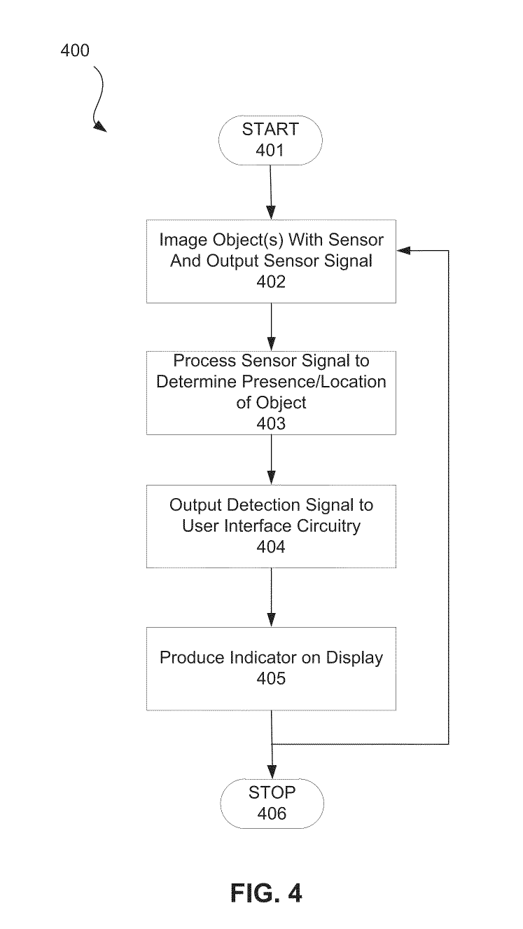

Another aspect of the present disclosure relates to methods for enhancing the peripheral vision of a human that is wearing a wearable apparatus including a system in accordance with the present disclosure. Reference is therefore made to FIG. 4, which provides a flow chart of an exemplary method in accordance with the present disclosure. As shown, method 400 begins at block 401. In this block, a user (E.g. a human being) may be provided with a wearable apparatus (e.g., eyewear) that includes a system consistent with the present disclosure.

At block 302, objects outside of the user's field of view are imaged by a sensor consistent with the present disclosure. As discussed previously, the sensor outputs a sensor signal containing information regarding the imaged environment within its field of view. The method may then proceed to block 403, wherein the sensor signal is processed with a processor to determine the presence and/or relative location of objects within the field of view of the sensor. Upon detecting an object, the processor outputs a detection signal to user interface circuitry, as shown in block 404 of FIG. 4. The method may then proceed to block 405, wherein the user interface circuitry causes an indicator to appear in a display of the wearable apparatus. Consistent with the foregoing discussion, the user interface circuitry may cause the indicators to appear in a region of a display that is outside the foveal vision of the user. More specifically, the user interface circuitry may cause an indicator to appear in a region of a display that the user can perceive with his/her peripheral vision, and without his/her foveal vision. In this way, the user may be alerted to the presence of an object outside his or her field of view without the user having to shift or refocus his/her fovial vision.

According to one aspect there is provided an eyewear apparatus configured to be worn over at least one eye. The eyewear apparatus may include a lens coupled to a frame. The lens may have a width W, a height W, and comprise a display configured to render an indicator. The eyewear apparatus may further include a sensor coupled to the frame. In this example, the sensor may be configured to image an environment and output a sensor signal. The eyewear apparatus may further include a processor in communication with the sensor. The processor may be configured to analyze the sensor signal and detect an object within a field of view of the sensor. In addition, the processor further configured to output a detection signal in response to detecting the object. The eyewear apparatus may also include user interface circuitry in communication with the processor. In this example, user interface circuitry causes the display to render the indicator in a region R of the display, wherein region R extends from a periphery of the lens to a position that is less than or equal to about 25% of H, less than or equal to about 25% of W, or a combination thereof.

Another example of an eyewear apparatus includes the foregoing components, wherein the sensor has a larger field of view than a view of view of the at least one eye.

Another example of an eyewear apparatus includes the foregoing components, wherein the display extends from a periphery of the lens to a position that is less than or equal to about 25% of H, less than or equal to about 25% of W, or a combination thereof.

Another example of an eyewear apparatus includes the foregoing components, wherein region R is outside a foveal field of view of the at least one eye, when the foveal field of view is oriented perpendicular to a center point of the lens. The foveal field of view of the at least one eye may have a horizontal width of less than or equal to about 15 degrees.

Another example of an eyewear apparatus includes the foregoing components, wherein the indicator is in the form of an unreadable symbol.

Another example of an eyewear apparatus includes the foregoing components, wherein the indicator is chosen from arbitrary symbols, white noise, fractal images, random flashes, semi-random flashes, and combinations thereof.

Another example of an eyewear apparatus includes the foregoing components, wherein the indicator is in the form of an arbitrary symbol.

Another example of an eyewear apparatus includes the foregoing components, wherein the processor is further configured to determine the position of an object within the field of view of the sensor, relative to the sensor.

Another example of an eyewear apparatus includes the foregoing components, wherein the position of the indicator within region R is indicative of the position of said object within said field of view of said sensor.

Another example of an eyewear apparatus includes the foregoing components, wherein the processor is further configured to determine additional information about an object present in the field of view of the sensor. The additional information may be chosen from the rate at which one or more of the objects are approaching the sensor, the number of detected objects, the distance of said one or more objects from the sensor, and combinations thereof.

Another example of an eyewear apparatus includes the foregoing components, wherein the user interface circuitry is configured to control at least one parameter of the indicator, such that the indicator is representative of additional information determined by the processor about an object in the field of view of the sensor. The at least one parameter may be chosen from indicator intensity, color, blink rate, animation, and combinations thereof.

Another example of an eyewear apparatus includes the foregoing components, wherein the display is chosen from a light emitting diode display, an organic electroluminescent display, a liquid crystal on silicon display, an organic light emitting diode display, and combinations thereof.

Another example of an eyewear apparatus includes the foregoing components, wherein the display includes a plurality of individually addressed pixels, and the indicator is formed from one or more of the pixels.

Another example of an eyewear apparatus includes the foregoing components, wherein region R extends from a periphery of the lens to a position that is less than or equal to about 15% of W, less than or equal to about 15% of H, or a combination thereof.

Another example of an eyewear apparatus includes the foregoing components, wherein the frame further includes at least one arm. The sensor may be coupled the at least one arm, e.g., such that its field of view is outside the field of view of the at least one eye.

Another example of an eyewear apparatus includes the foregoing components, wherein the sensor is embedded in the frame.

According to another aspect there is provided a method. The method may include using a sensor coupled to eyewear to image an environment within a field of view of the sensor, the eyewear being configured to be worn over at least one eye comprising a lens, the lens having a width W, a height H, and including a display. The method may further include detecting an object within the field of view of the sensor. In response to detecting the object, the method may further include producing an indicator in a region R of the display, wherein region R extends from a periphery of the lens to a position that is less than or equal to about 25% of H, 25% of W, or a combination thereof.

Another example of a method includes the foregoing components, wherein the display extends from a periphery of the lens to a position that is less than or equal to about 25% of H, 25% of W, or a combination thereof.

Another example of a method includes the foregoing components, wherein the region R extends from a periphery of said lens to a position that is less than or equal to about 15% of H, 15% of W, or a combination thereof.

Another example of a method includes the foregoing components, wherein the indicator includes an unreadable symbol.

Another example of a method includes the foregoing components, wherein the indicator is chosen from arbitrary symbols, white noise, fractal images, random flashes, semi-random flashes, and combinations thereof.

Another example of a method includes the foregoing components, wherein the indicator is in the form of an arbitrary symbol.

Another example of a method includes the foregoing components, and further includes determining the position of an object within said field of view of said sensor, relative to said sensor. In some embodiments, the position of the indicator within region R is indicative of the position of said object within said field of view of the sensor.

Another example of a method includes the foregoing components, wherein the display is chosen from a light emitting diode display, an organic electro luminescent display, a liquid crystal on silicon display, an organic light emitting diode display, and combinations thereof.

Another example of a method includes the foregoing components, wherein the display extends from a periphery of the lens to a position that is less than or equal to about 15% of H, 15% of W, or a combination thereof.

Another example of a method includes the foregoing components, wherein the eyewear includes a frame that includes at least one arm, and sensor is coupled to the at least one arm.

According to another aspect there is provided a computer readable medium. The computer readable medium includes object detection instructions stored therein. The object detection instructions when executed by a processor cause the processor to analyze a sensor signal output by a sensor coupled to eyewear to detect an object within a field of view of the sensor, the eyewear comprising a lens having a width W, a height H, the lens further comprising a display. The object detection instructions when executed by a processor cause the processor to, in response to detecting said object, output a detection signal configured to cause a production of an indicator in a region R of the display, wherein region R extends from a periphery of the lens to a position that is less than or equal to about 25% of H, 25% of W, or a combination thereof.

Another example of a computer readable medium includes the foregoing components, wherein region R extends from a periphery of the lens to a position that is less than or equal to about 15% of H, 15% of W, or a combination thereof.

Another example of a computer readable medium includes the foregoing components, wherein the object detection instructions when executed further cause the processor to configure the detection signal such that the indicator comprises an unreadable symbol.

Another example of a computer readable medium includes the foregoing components, wherein the object detection instructions when executed further cause the processor to configure the detection signal such that said indicator is in the form of one or more arbitrary symbols, white noise, fractal images, random flashes, semi-random flashes, and combinations thereof.

Another example of a computer readable medium includes the foregoing components, wherein the object detection instructions when executed further cause the processor to configure the detection signal such that said indicator is an arbitrary symbol.

Another example of a computer readable medium includes the foregoing components, wherein the object detection instructions when executed further cause the processor to determine the position of the object relative to the sensor.

Another example of a computer readable medium includes the foregoing components, wherein the object detection instructions when executed further cause the processor to configure the detection signal such that a position of the indicator within region R is indicative of the position of the object within the field of view of the sensor.

Another example of a computer readable medium includes the foregoing components, wherein the object detection instructions when executed further cause the processor to determine a distance of the object from the sensor.

Another example of a computer readable medium includes the foregoing components, wherein the object detection instructions when executed further cause the processor to configure the detection signal such that a parameter of the indicator is indicative of the distance of the object. In such example, the parameter is chosen from a color of the indicator, number of the indicator, position of the indicator, intensity of the indicator, animation speed of the indicator, blink rate of the indicator, intensity of the indicator, pattern of the indicator, and combinations thereof.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. Thus, the breadth and scope of the present invention should not be limited by any of the above-described exemplary embodiments, but should be defined only in accordance with the following claims and their equivalents.

What is claimed is:

1. An eyewear apparatus configured to be worn over at least one eye, comprising:
a lens coupled to a frame, said lens having a width W and a height H and comprising a display configured to render an indicator;
a sensor coupled to the frame, said sensor being configured to image an environment and output a sensor signal;
a processor in communication with said sensor, said processor configured to analyze said sensor signal and detect an object within a field of view of said sensor, said processor further configured to output a detection signal in response to detecting said object; and
user interface circuitry in communication with said processor;
wherein:
in response to receiving said detection signal, said user interface circuitry causes said display to render said indicator in a region R of said display, wherein region R extends from a periphery of said lens to a position that is less than or equal to about 25% of H, less than or equal to about 25% of W, or a combination thereof.

2. The apparatus of claim 1, wherein said field of view of said sensor is larger than a field of view of said at least one eye.

3. The apparatus of claim 1, wherein said display extends from a periphery of said lens to a position that is less than or equal to about 25% of H, less than or equal to about 25% of W, or a combination thereof.

4. The apparatus of claim 1, wherein said region R is outside a foveal field of view of said at least one eye, when said foveal field of view is oriented perpendicular to a center point of said lens.

5. The apparatus of claim 4, wherein said foveal field of view of said at least one eye has a horizontal width of less than or equal to about 15 degrees.

6. The apparatus of claim 1, wherein said indicator comprises an unreadable symbol.

7. The apparatus of claim 1, wherein said indicator is chosen from arbitrary symbols, white noise, fractal images, random flashes, semi-random flashes, and combinations thereof.

8. The apparatus of claim 7, wherein said indicator is an arbitrary symbol.

9. The apparatus of claim 1, wherein said processor is further configured to determine the position of an object within said field of view of said sensor, relative to said sensor.

10. The apparatus of claim 9, wherein a position of said indicator within region R is indicative of the position of said object within said field of view of said sensor.

11. The apparatus of claim 1, wherein said processor is further configured to determine additional information about an object present in said field of view of said sensor, wherein said additional information is chosen from the rate at which one or more of said objects are approaching said sensor, the number of detected objects, the distance of said one or more objects from said sensor, and combinations thereof.

12. The apparatus of claim 11, wherein said user interface circuitry is configured to control at least one parameter of said indicator, such that said indicator is representative of said additional information.

13. The apparatus of claim 12, wherein said at least one parameter of said indicator is chosen from intensity, color, blink rate, animation, and combinations thereof.

14. The apparatus of claim 1, wherein said display is chosen from a light emitting diode display, an organic electroluminescent display, a liquid crystal on silicon display, an organic light emitting diode display, and combinations thereof.

15. The apparatus of claim 1, wherein said display comprises a plurality of individually addressed pixels, and said indicator is formed from one or more of said pixels.

16. The apparatus of claim 1, wherein said region R extends from a periphery of said lens to a position that is less than or equal to about 15% of W, less than or equal to about 15% of H, or a combination thereof.

17. The apparatus of claim 1, wherein said frame further comprises at least one arm, and said sensor is coupled to said at least one arm.

18. The apparatus of claim 17, wherein said sensor is coupled to said at least one arm such that its field of view is outside a field of view of said at least one eye.

19. The apparatus of claim 1, wherein said sensor is embedded in said frame.

20. A method, comprising:
using a sensor coupled to eyewear to image an environment within a field of view of said sensor, said eyewear being configured to be worn over at least one eye and comprising a lens, wherein said lens has a width W, a height H, the lens further comprising a display;
detecting an object within said field of view of said sensor; and
in response to said detecting, producing an indicator in a region R of said display, wherein region R extends from a periphery of said lens to a position that is less than or equal to about 25% of H, 25% of W, or a combination thereof.

21. The method of claim 20, wherein said display extends from a periphery of said lens to a position that is less than or equal to about 25% of H, 25% of W, or a combination thereof.

22. The method of claim 21, wherein said region R extends from a periphery of said lens to a position that is less than or equal to about 15% of H, 15% of W, or a combination thereof.

23. The method of claim 20, wherein said indicator comprises an unreadable symbol.

24. The method of claim 20, wherein said indicator is chosen from arbitrary symbols, white noise, fractal images, random flashes, semi-random flashes, and combinations thereof.

25. The method of claim 24, wherein said indicator is an arbitrary symbol.

26. The method of claim 20, further comprising determining the position of an object within said field of view of said sensor, relative to said sensor.

27. The method of claim 26, wherein a position of said indicator within region R is indicative of the position of said object within said field of view of said sensor.

28. The method of claim 20, wherein said display is chosen from a light emitting diode display, an organic electroluminescent display, a liquid crystal on silicon display, an organic light emitting diode display, and combinations thereof.

29. The method of claim 22, wherein said display extends from a periphery of said lens to a position that is less than or equal to about 15% of H, 15% of W, or a combination thereof.

30. The method of claim 20, wherein said eyewear comprises a frame that includes at least one arm, and said sensor is coupled to said at least one arm.

31. A computer readable medium having object detection instructions stored therein, wherein said object detection instructions when executed by a processor causes said processor to perform the following operations comprising:
analyze a sensor signal output by a sensor coupled to eyewear to detect an object within a field of view of said sensor, said eyewear comprising a lens having a width W, a height H, the lens further comprising a display; and
in response to detecting said object, output a detection signal configured to cause a production of an indicator in a region R of said display, wherein region R extends from a periphery of said lens to a position that is less than or equal to about 25% of H, 25% of W, or a combination thereof.

32. The computer readable medium of claim 31, wherein said region R extends from a periphery of said lens to a position that is less than or equal to about 15% of H, 15% of W, or a combination thereof.

33. The computer readable medium of claim 31, wherein said object detection instructions when executed further cause said processor to configure said detection signal such that said indicator comprises an unreadable symbol.

34. The computer readable medium of claim 31, wherein said object detection instructions when executed further cause said processor to configure said detection signal such that said indicator is in the form of one or more arbitrary symbols, white noise, fractal images, random flashes, semi-random flashes, and combinations thereof.

35. The computer readable medium of claim 34, wherein said object detection instructions when executed further cause said processor to configure said detection signal such that said indicator is an arbitrary symbol.

36. The computer readable medium of claim 31, wherein said object detection instructions when executed further cause said processor to determine the position of said object relative to said sensor.

37. The computer readable medium of claim 36, wherein said object detection instructions when executed further cause said processor to configure said detection signal such that a position of said indicator within region R is indicative of said position of said object within said field of view of said sensor.

38. The computer readable medium of claim 31, wherein said object detection instructions when executed further cause said processor to determine a distance of said object from said sensor.

39. The computer readable medium of claim 38, wherein said object detection instructions when executed further cause said processor to configure said detection signal such that a parameter of said indicator is indicative of said distance, said parameter being chosen from a color of said indicator, number of said indicator, position of said indicator, intensity of said indicator, animation speed of said indicator, blink rate of said indicator, intensity of said indicator, pattern of said indicator, and combinations thereof.
